(19) United States
(12) Patent Application Publication
(10) Pub. No.: US 2014/0149970 A1
(43) Pub. Date: May 29, 2014

(54) OPTIMISING A COMPILATION PARSER FOR PARSING COMPUTER PROGRAM CODE IN ARBITRARY APPLICATIONS

(71) Applicant: International Business Machines Corporation, Armonk, NY (US)

(72) Inventors: William Duchenay, Cork (IE); Thierry P. Supplisson, Cork (IE)

(73) Assignee: International Business Machines Corporation, Armonk, NY (US)

(21) Appl. No.: 14/092,838

(22) Filed: Nov. 27, 2013

(30) Foreign Application Priority Data
Nov. 29, 2012 (GB) 1221449.0

(51) Int. Cl. G06F 9/45

(52) U.S. Cl. CPC G06F 8/427
USPC 717/143

(57) ABSTRACT

A mechanism is provided for optimising a grammar definition and compilation parser for parsing an arbitrary application computer language in which a parser is run against an indicative sample of the arbitrary application computer programming language in order to determine the required scope of the grammar for the parser.

### BACKGROUND

The present invention relates to optimising a grammar and compilation parser for parsing a computer programming language used in arbitrary applications.

Computer programs are engineered using a programming language, often referred to as source code. The source code for a given arbitrary application program is then compiled or interpreted in order to be run on a given computer processor. The compilation or interpretation process, performed by the compiler or interpreter application programs, commonly comprises a parsing process in which a body of program code in a given programming language is checked for compliance with the respective grammar for the programming language. In other words, the body of code is analysed to ensure that it conforms to the grammar rules or productions for the relevant programming language. If the body of program code complies with the relevant grammar then its processing can proceed to the next stage in the compilation or interpretation process. If the body of code does not comply with the grammar then a parsing error can be signalled.

One problem is that the grammars for some programming languages are large and complex and thus result in correspondingly large and complex parser functionality either as stand-alone parser programs or within compiler or interpreter programs.

Therefore, there is a need in the art to address the aforementioned problem.

### SUMMARY

In an illustrative embodiment, an apparatus is provided for optimising a compilation parser for parsing arbitrary application code. The apparatus comprises a first generate component for generating a first parser for parsing a programming language in accordance with a first grammar comprising a first set of grammar productions; a run component for running the first parser against a first sample of the programming language; an identify component for identifying the subset of the first set of grammar productions used for parsing the first sample of the programming language; and a second generate component for generating a second parser for parsing the programming language in accordance with a second grammar, of reduced scope relative to the first grammar, comprising the identified subset of the first set of grammar productions.

In another illustrative embodiment, a computer implemented method is provided for optimising a compilation parser for parsing computer program code. The method comprises creating a first parser for parsing a programming language in accordance with a first grammar comprising a first set of grammar productions; running the first parser against a first sample of the programming language; identifying the subset of the first set of grammar productions used for parsing the first sample of the programming language; and creating a second parser for parsing the programming language in accordance with a second grammar, of reduced scope relative to the first grammar, comprising the identified subset of the first set of grammar productions.

In another illustrative embodiment, a computer program product is proivded for optimising a compilation parser for parsing computer program code, the computer program product comprising a computer readable storage medium readable by a processing circuit and storing instructions for execution by the processing circuit for performing a method for performing the steps of the invention.

### BRIEF DESCRIPTION OF THE DRAWINGS

Preferred embodiments of the invention will now be described, by way of example only, with reference to the following drawings in which:

FIG. 1 is a block diagram of a computer system in which a compilation parser generation application program is arranged to generate a parser from an input grammar, according to an illustrative embodiment;

FIG. 2 is a block diagram of a computer system in which a parser optimisation application program is arranged to run a parser against a code sample in order to produce an optimised parser, according to an illustrative embodiment;

FIG. 3 is a flow chart illustrating the processing performed by the compilation parser generation application program when generating the parser from the input grammar, according to an illustrative embodiment;

FIG. 4 is a flow chart illustrating the processing performed by the parser optimisation application program when producing the optimised parser, according to an illustrative embodiment; and

FIG. 5 is a flow chart illustrating the processing performed by the parser optimisation application program when reverting from the optimised parser to the input parser, according to an illustrative embodiment.

### DETAILED DESCRIPTION

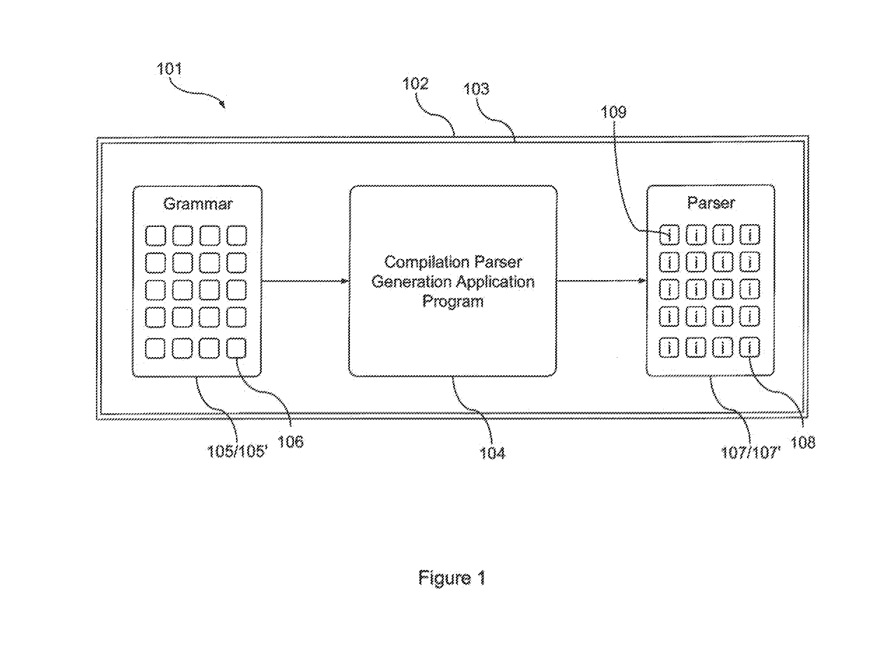

With reference to FIG. 1, a first computer system 101 comprises a computer 102 running an operating system 103 providing a processing platform for the processing of one or more arbitrary application programs. The application programs are “arbitrary” in that they are “any” application written in a selected programming language. Indeed in example embodiments, the selected programming language can be any programming language. In the illustrative embodiment, the computer 102 is running a compilation parser generation application program 104 arranged to input data representing a grammar 105 for the selected programming language. The grammar 105 specifies a set of grammar constructs or productions 106 which define the selected programming language. The compilation parser generation application program 104 is arranged to output a parser program 107 for parsing any body of source code in the selected programming language. The parser 107 comprises an internal representation of the grammar 105 in the form of a set of production rules 108 corresponding to the set of grammar productions 106. In other words, each of the production rules 108 are correlated with a respective grammar production 106. In the illustrative embodiment, the code of the output parser 107 is optionally provided with instrumentation code 109. Instrumentation code 109 is optionally associated with each production rule 108 and arranged to provide data indicating whether the respective associated production rule 108 has been used during the parsing of a given body of source code as described below. The option governing whether or not to include the instrumentation code 109 in the output parser 107 is selected in conjunction with the input of the grammar 105.

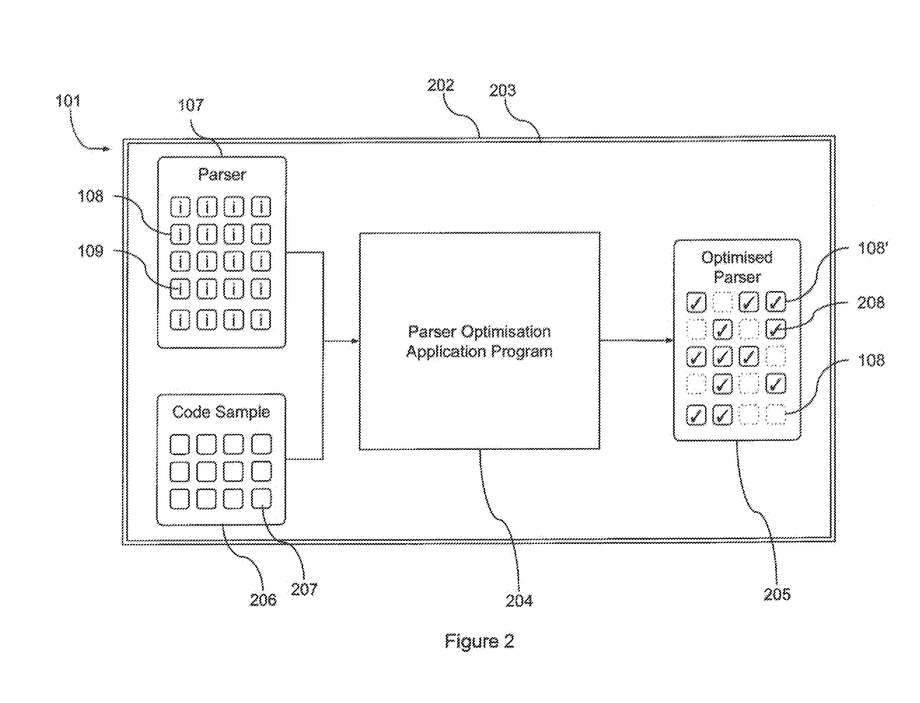

With reference to FIG. 2, a second computer system 201 comprises a computer 202 running an operating system 203 providing a processing platform for the processing of one or more application programs. In the illustrative embodiment, the computer 202 is running a parser optimisation application program 204 arranged to optimise an input parser program 107 to produce an optimised parser 205. The parser optimisation application program 204 is arranged to input a code sample 206 in conjunction with the parser 107 to be optimised. The code sample 206 comprises an indicative set of code elements 207 in the selected programming language that the parser 107 is arranged to parse. The code sample 206 is arranged to be representative of the set of grammar constructs or productions 106 that the parser 107 is required to parse in use. In other words, the code sample 206 is a practical representation of the scope of the grammar 105. Generally, the code sample 206 will represent a subset of the original grammar 105 from which the parser 107 was generated by the compilation parser generation application program 104.

The parser optimisation application program 204 is arranged to run the input parser 107 against the code sample 206 and to collect the data 208 generated by the instrumentation code 109 during this parsing process. The data 208 generated by the instrumentation code 109 indicates the subset of production rules 108′ that were exercised or used by the running of the parser 107 against the code sample 206. In the illustrative embodiment, the parser optimisation application program 204 uses the data 208 from the instrumentation code 109 to identify the grammatical constructs 106 of the grammar 105 which were not exercised and then removes these unused grammatical constructs 106 from the grammar to create an optimised grammar 105′. The parser optimisation application program 204 then generates an optimised parser 107′ by inputting the optimised grammar 105′ to the compilation parser generation application program 104. The optimised parser 107′ is thus optimised to operate in accordance with the optimised grammar 105′ as represented by the code sample 206. In the illustrative embodiment, the optimised parser 107′ is produced without any added instrumentation code.

In some cases the optimised parser 107′ may not be able to parse a given body of the programming language due to one or more grammar productions 106 present in the given body of the programming language having been optimised out of the optimised parser 107′. In the illustrative embodiment, a reversion process is provided for reverting from the use of the optimised parser 107′ to the non-optimised parser 107. In the illustrative embodiment, the compilation parser generation application program 104 is thus arranged to produce a non-instrumented version of the non-optimised parser 107 so as to enable the parsing of the given body of the programming language.

An apparatus for optimising a compilation parser for parsing arbitrary application code comprises various optional components: a first generate component; a run component; an identify component; a second generate component; a third generate component; a revert component; an instrumenting component; a de-instrumenting component; and a further run component.

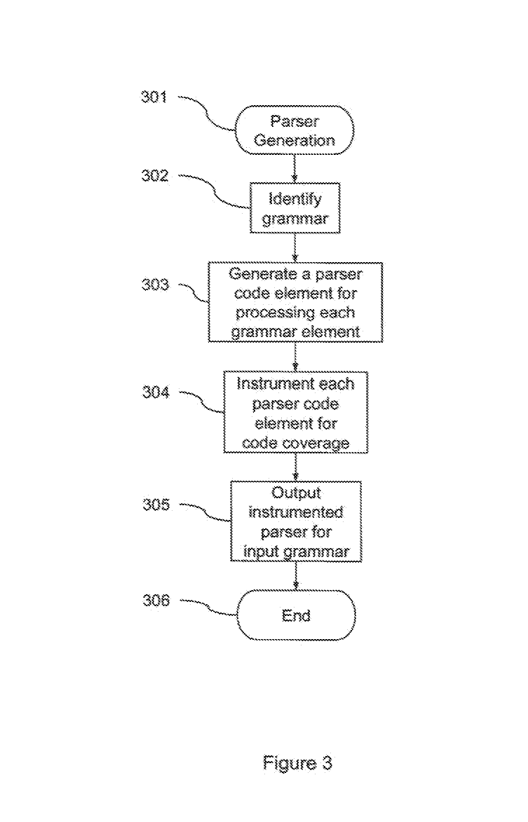

The processing performed by the compilation parser generation application program 104 when producing a parser 107/107′ from a grammar 105/105′ will now be described further with reference to FIG. 3. Processing is initiated at step 301 in response to user initiation of the parser generation process and processing moves to step 302. At step 302 the grammar 105/105′ for which the parser 107/107′ is to be generated is identified and processing moves to step 303. At step 303 the first generate component of the apparatus generates the parser program 107/107′ comprising a respective code element 108 for processing each grammar production 106 of the grammar 105/105′ and processing moves to step 304. At step 304, if the instrumentation option for the output parser 107 is selected then instrumentation code 109 is added to the parser 107 arranged to produce data indicative of each respective code element 108 being processed in a given parsing operation and processing then moves to step 305. At step 305 the generated parser program 107/107′ is output and processing then moves to step 306 and ends.

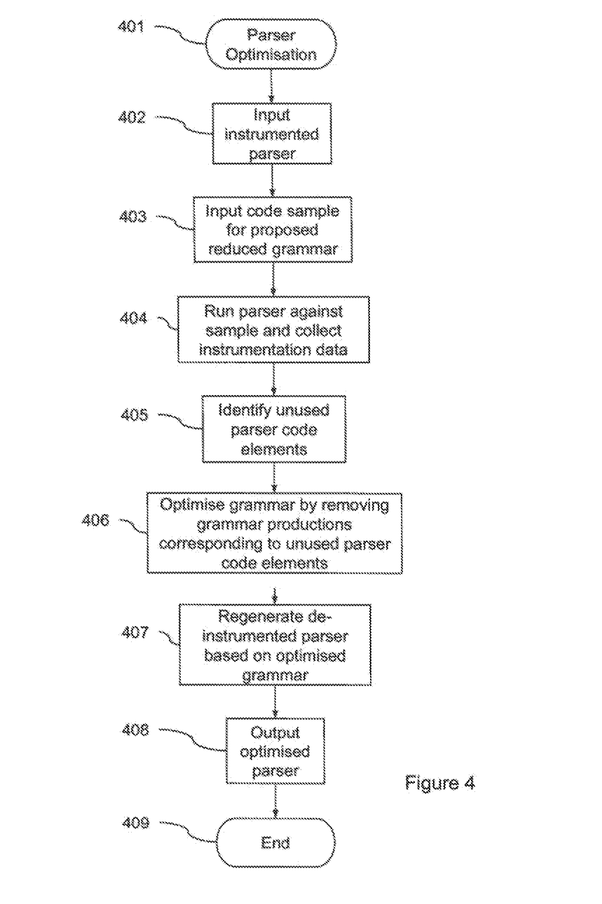

The processing performed by the parser optimisation application program 204 when optimising a parser will now be described with reference to the flow chart of FIG. 4. Processing is initiated at step 401 in response to user input or automatically in response to the production of an instrumented parser 107 by the compilation parser generation application program 104 and processing moves to step 402. At step 402 the instrumented parser 107 is input and processing moves to step 403. At step 403 the code sample 206 against which the instrumented parser 107 is to be run is input and processing moves to step 404. At step 404 the run component of the apparatus runs the instrumented parser 107 against the code sample 206 and data from the instrumentation code 109 is collected and processing moves to step 405. At step 405 the identify component of the apparatus uses the data collected from the instrumentation code 109 to identify the unused code elements 108 in the parser 107 and processing moves to step 406. At step 406, the unused code elements 108 are correlated with the corresponding grammar productions 106 in the grammar 206 for which the parser 107 was created and those grammar productions 106 removed to produce an optimised grammar 105′ and processing moves to step 407. At step 407 the optimised grammar 105′ is input to the parser generation application program 104 so that the second generate component of the apparatus generates a corresponding optimised parser 107′ and processing moves to step 408. At step 408 the optimised parser 107′ is output for use in parsing bodies of code in the programming language accordance with the scope of the optimised grammar 105′ as exemplified by the code sample 206. Processing then moves to step 409 and ends. Optionally, the output optimised parser 107′ may be tested against the code sample 206 to confirm expected operation. In an alternative embodiment, the further run component of the apparatus can run the optimised parser against a body of code of an application in the programming language to provide a parsed body of code.

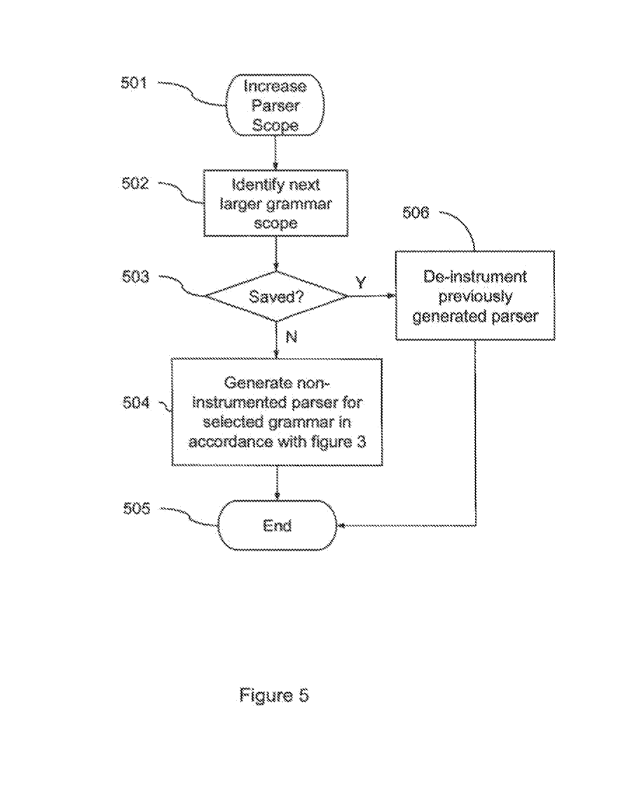

The processing performed by the parser optimisation application program 204 when reverting the scope of an optimised parser will now be described with reference to the flow chart of FIG. 5. Processing is initiated at step 501 in response to user request to revert an optimised parser 107′ to a parser having broader grammar scope such as the original, master parser 107 and processing moves to step 502. At step 502 the relevant grammar 105 is identified and processing moves to step 503. At step 503 a check is performed to determine whether or not a parser 107 for the identified grammar 105 has been previously generated and saved and if not processing moves to step 504. At step 504 the revert component produces a non-instrumented parser for the identified grammar in accordance with the process of FIG. 3 and output and processing moves to step 505 and ends. If at step 503 a previously created parser 107 for the identified grammar is identified then processing moves to step 506. At step 506, if necessary, the de-instrument component de-instruments any instrumentation code 109 present in the identified saved parser prior to the parser being output and processing then moves to step 505 and ends.

In another embodiment, the run component runs an instrumented master or instrumented optimised parser against further respective code samples in accordance with the method of FIG. 4 and a third generate component generates further optimised parsers operable to parse the programming language in accordance with respective reduced scope grammars. The set of optimised parsers produced provides further choice for reversion in the case where a given parser's scope proves too narrow for a given parsing application. Such a set of parsers may be mapped to a tree or other suitable data structure so as to represent the relationship between the respective grammar scopes. Such a data structure may be used for selecting the appropriate parser in the reversion process described above.

In a further embodiment, when a given parser is optimised, instead of removing the unused code elements, the unused code elements are maintained in the parser but disabled. The reversion process then comprises re-enabling one or more selected code elements in the parser.

In another embodiment, the optimisation process comprises removing only a selected subset of the unused code elements identified when running the parser against a given code sample.

In a further embodiment, the parser being optimised comprises an LL(*) or LL(k) parser and the unused grammar productions are used to identify unnecessary predicates and to reduce look-ahead in the optimised parser.

As will be appreciated by one skilled in the art, aspects of the present invention may be embodied as a system, method, computer program product or computer program. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Java and all Java-based trademarks and logos are trademarks or registered trademarks of Oracle and/or its affiliates.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

For the avoidance of doubt, the term “comprising”, as used herein throughout the description and claims is not to be construed as meaning “consisting only of”.

It will be understood by those skilled in the art that the apparatus that embodies a part or all of the present invention may be a general purpose device having software arranged to provide a part or all of an embodiment of the invention. The device could be a single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details of the representative apparatus and method, and illustrative examples shown and described. Accordingly, departures may be made from such details without departure from the scope of applicant's general inventive concept.

1. An apparatus for optimising a compilation parser for parsing arbitrary application code, the apparatus comprising:
a processor; and
a memory coupled to the processor, wherein the memory comprises a computer readable program executable by the processor, the computer readable program comprising:
a first generate component for generating a first parser for parsing a programming language in accordance with a first grammar comprising a first set of grammar productions;
a run component for running the first parser against a first sample of the programming language;
an identify component for identifying the subset of the first set of grammar productions used for parsing the first sample of the programming language; and
a second generate component for generating a second parser for parsing the programming language in accordance with a second grammar, of reduced scope relative to the first grammar, comprising the identified subset of the first set of grammar productions.

2. An apparatus according to claim 1, wherein the second generate component is further operable for creating the second grammar by the removal from the first grammar of one or more of the grammar productions not used when parsing the sample of the programming language.

3. An apparatus according to claim 1, wherein:
the run component is further operable for running the first or second parser against a second sample of the programming language;
the identify component is further operable for identifying the subset of the respective first or second set of grammar productions used for parsing the second sample of the programming language; and
a third generate component for generating a third parser for parsing the programming language in accordance with a third grammar, of reduced scope relative to the respective first or second grammar, comprising the identified subset of the respective first or second set of grammar productions.

4. An apparatus according to claim 3, the computer readable program further comprising a revert component, responsive to the scope of the grammar of the second or third parser being inadequate for parsing the programming language, for reverting to the first or second parser having a greater scope of grammar for subsequent parsing of the programming language.

5. An apparatus according to claim 1, the computer readable program further comprising an instrumenting component for instrumenting the first or second parser for producing data identifying the subset of grammar productions used for parsing the respective first sample of the programming language.

6. An apparatus according to claim 5, the computer readable program further comprising a de-instrumenting component for de-instrumenting the second parser created for parsing the programming language in accordance with the respective second grammar.

7. An apparatus according to claim 1 wherein the computer readable program further comprises a further run component for running the second parser on a body of code of an application in the programming language to provide a parsed body of code.

8. A computer implemented method for optimising a compilation parser for parsing computer program code, the method comprising:
creating a first parser for parsing a programming language in accordance with a first grammar comprising a first set of grammar productions;
running the first parser against a first sample of the programming language;
identifying the subset of the first set of grammar productions used for parsing the first sample of the programming language; and
creating a second parser for parsing the programming language in accordance with a second grammar, of reduced scope relative to the first grammar, comprising the identified subset of the first set of grammar productions.

9. A method according to claim 8, wherein the second grammar is created by the removal from the first grammar of one or more of the grammar productions not used when parsing the sample of the programming language.

10. A method according to claim 8, comprising:
running the first or second parser against a second sample of the programming language;
identifying the subset of the respective first or second set of grammar productions used for parsing the second sample of the programming language; and
creating a third parser for parsing the programming language in accordance with a third grammar, of reduced scope relative to the respective first or second grammar, comprising the identified subset of the respective first or second set of grammar productions.

11. A method according to claim 10 in which in response to the scope of the grammar of the second or third parser being inadequate for parsing the programming language then reverting to the first or second parser having a greater scope of grammar for subsequent parsing of the programming language.

12. A method according claim 8, wherein the first or second parser is instrumented for producing data identifying the subset of grammar productions used for parsing the respective first or second sample of the programming language.

13. A method according to claim 12, wherein the second parser created for parsing the programming language in accordance with the respective second grammar is de-instrumented.

14-16. (canceled)

17. A computer program product comprising a computer readable storage medium having a computer readable program stored therein, wherein the computer readable program, executable by a computing device, comprises:
a first generate component for generating a first parser for parsing a programming language in accordance with a first grammar comprising a first set of grammar productions;
a run component for running the parser against a first sample of the programming language;
an identify component for identifying the subset of the first set of grammar productions used for parsing the first sample of the programming language; and
a second generate component for generating a second parser for parsing the programming language in accordance with a second grammar, of reduced scope relative to the first grammar, comprising the identified subset of the first set of grammar productions.

18. A computer program product according to claim 17, wherein the second generate component is further operable for creating the second grammar by the removal from the first grammar of one or more of the grammar productions not used when parsing the sample of the programming language.

19. A computer program product according to claim 17, wherein:
the run component is further operable for running the first or second parser against a second sample of the programming language;
the identify component is further operable for identifying the subset of the respective first or second set of grammar productions used for parsing the second sample of the programming language; and
a third generate component for generating a third parser for parsing the programming language in accordance with a third grammar, of reduced scope relative to the respective first or second grammar, comprising the identified subset of the respective first or second set of grammar productions.

20. A computer program product according to claim 19, the computer readable program further comprising a revert component, responsive to the scope of the grammar of the second or third parser being inadequate for parsing the programming language, for reverting to the first or second parser having a greater scope of grammar for subsequent parsing of the programming language.

21. A computer program product according to claim 17, the computer readable program further comprising an instrumenting component for instrumenting the first or second parser for producing data identifying the subset of grammar productions used for parsing the respective first sample of the programming language.

22. A computer program product according to claim 21, the computer readable program further comprising a de-instrumenting component for de-instrumenting the second parser created for parsing the programming language in accordance with the respective second grammar.

23. A computer program product according to claim 17 wherein the computer readable program, further comprises a further run component for running the second parser on a body of code of an application in the programming language to provide a parsed body of code.
